(19) United States
(12) Patent Application Publication
(10) Pub. No.: US 2022/0415007 A1
(43) Pub. Date: Dec. 29, 2022

(54) IMAGE NORMALIZATION PROCESSING

(71) Applicant: SHENZHEN SENSETIME TECHNOLOGY CO., LTD., Shenzhen (CN)

(72) Inventors: Ruimao ZHANG, Shenzhen (CN); Zhanglin PENG, Shenzhen (CN); Lingyun WU, Shenzhen (CN); Ping LUO, Shenzhen (CN)

(21) Appl. No.: 17/893,797

(22) Filed: Aug. 23, 2022

Related U.S. Application Data
(63) Continuation of application No. PCT/CN2020/103575, filed on Jul. 22, 2020.

(30) Foreign Application Priority Data
Feb. 27, 2020 (CN) 202010123511.8

(51) Int. Cl. G06V 10/32; G06V 10/77; G06V 10/82

(52) U.S. Cl. CPC G06V 10/32; G06V 10/7715; G06V 10/82

(57) ABSTRACT

Methods, systems, electronic devices, and computer-readable storage media for image normalization processing are provided. In one aspect, an image normalization processing method includes: normalizing a feature map by respectively using K normalization factors to obtain K candidate normalized feature maps; for each of the K normalization factors, determining a first weight value for the normalization factor; and determining a target normalized feature map corresponding to the feature map based on the candidate normalized feature map corresponding to each of the K normalization factors and the first weight value for each of the K normalization factors. The K candidate normalized feature maps and the K normalization factors have a one-to-one correspondence, and K is an integer greater than 1.

### CROSS REFERENCE TO RELATED APPLICATIONS

The present disclosure is a continuation of International Application No. PCT/CN2020/103575, filed on Jul. 22, 2020, which claims priority to Chinese Patent Application No. 2020123511.8, filed on Feb. 27, 2020, and entitled “IMAGE NORMALIZATION PROCESSING METHOD AND APPARATUS AND STORAGE MEDIUM”, both of which are hereby incorporated herein by reference in their entireties.

### TECHNICAL FIELD

The present disclosure relates to the field of deep learning, and in particular, to methods, electronic devices, and storage media for image normalization processing.

### BACKGROUND

In tasks such as natural language processing, speech recognition, and computer vision, various normalization techniques have become essential modules for deep learning. Normalization techniques usually compute statistics in different dimensions of an input tensor, such that different normalization processing methods are applicable to different vision tasks.

### SUMMARY

Implementations of the present disclosure provide methods, electronic devices, and storage media for image normalization processing.

A first aspect of the present disclosure provides an image normalization processing method, which includes: normalizing a feature map by respectively using K normalization factors, to obtain K candidate normalized feature maps, wherein the K candidate normalized feature maps and the K normalization factors have a one-to-one correspondence, and K is an integer greater than 1; for each of the K normalization factors, determining a first weight value for the normalization factor; and determining a target normalized feature map corresponding to the feature map based on the candidate normalized feature map corresponding to each of the K normalization factors and the first weight value for each of the K normalization factors.

A second aspect of the present disclosure provides an image normalization processing apparatus, which includes: a normalizing module, configured to normalize a feature map by respectively using K normalization factors, to obtain K candidate normalized feature maps, wherein the K candidate normalized feature maps and the K normalization factors have a one-to-one correspondence, and K is an integer greater than 1; a first determining module, configured to, for each of the K normalization factors, determine a first weight value for the normalization factor; and a second determining module, configured to determine a target normalized feature map corresponding to the feature map based on the candidate normalized feature map corresponding to each of the K normalization factors and the first weight value for each of the K normalization factors.

A third aspect of the present disclosure provides a computer-readable storage medium having stored thereon a computer program that, when being executed by a processor, causes the processor to implement the image normalization processing method according to the first aspect of the present disclosure.

A fourth aspect of the present disclosure provides an electronic device , which includes: a processor; and a memory for storing instructions executable by the processor; wherein the processor is configured to execute the instructions stored in the memory to implement the image normalization processing method according to the first aspect of the present disclosure.

A fifth aspect of the present disclosure provides a computer program product having stored thereon computer-readable instructions that, when being executed by a processor, causes the processor to implement the image normalization processing method according to the first aspect of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the present disclosure.

FIG. 1 is a schematic flowchart of an image normalization processing method in accordance with an exemplary embodiment of the present disclosure;

FIG. 2 is a schematic flowchart of step 120 in accordance with an exemplary embodiment of the present disclosure;

FIG. 3 is a schematic flowchart of step 121 in accordance with an exemplary embodiment of the present disclosure;

FIG. 4 is a schematic flowchart of step 122 in accordance with an exemplary embodiment of the present disclosure;

FIG. 5 is a schematic flowchart of step 123 in accordance with an exemplary embodiment of the present disclosure;

FIG. 6 is a schematic flowchart of step 130 in accordance with an exemplary embodiment of the present disclosure;

FIG. 7 is a schematic diagram of normalization of image in accordance with an exemplary embodiment of the present disclosure;

FIG. 8 is a schematic structural diagram of an image normalization processing apparatus in accordance with an exemplary embodiment of the present disclosure;

FIG. 9 is a schematic structural diagram of an electronic device in accordance with an exemplary embodiment of the present disclosure.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of devices and methods consistent with some aspects of the present disclosure as detailed in the appended claims.

The terms used herein are for the purpose of describing particular embodiments only and is not intended to be limiting of the present disclosure. As used herein, the singular forms “a”, “said” and “the” are intended to include the plural forms as well, unless the context clearly indicates otherwise. It will also be understood that the term “and/or” includes any and all combinations of one or more of the associated listed items.

It will be understood that while terms such as “first”, “second”, “third”, etc. may be used to describe to describe various information, such information should not be limited to these terms. These terms are used only to distinguish the same type of information from each other. For example, without departing from the scope of the present disclosure, a first information may also be referred to as a second information, and similarly, a second information may also be referred to as a first information. Depending on the context, as used herein, the wording “if” may be interpreted as “while . . . ” or “when . . . ” or “in response to determining”.

The Switchable Normalization (SN) method adaptively combines different normalization operators linearly for each convolutional layer, allowing each layer in a deep neural network to optimize its own independent normalization processing method for a variety of vision tasks. However, although SN may learn different normalization parameters for different network structures and different data sets, it does not dynamically adjust the normalization parameters according to changes of sample features. The flexibility of normalization is limited, and a better deep neural network cannot be obtained.

Embodiments of the present disclosure provide an image normalization processing method, which may be applied to different network models and vision tasks. First weight values for different normalization factors are adaptively determined based on a feature map, and thus the flexibility of the normalization algorithm is improved. In the field of image processing, image content may be recognized so as to output corresponding results, which may be specifically, but not limited to, techniques such as image recognition, target detection, and target segmentation. Recognition of image content may usually involve extracting image features in the image first, and then outputting recognition results based on the extracted features. For example, when performing face recognition, face features in the image may be extracted and an attribute of the face may be recognized based on the extracted face features. It will be understood that the image normalization processing method provided by embodiments of the present disclosure may be applied in the field of image processing.

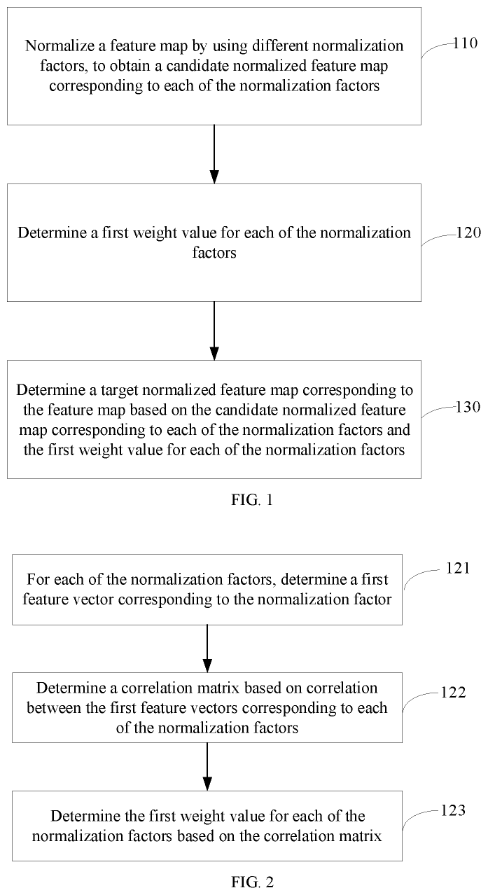

As shown in FIG. 1, the image normalization processing method according to one exemplary embodiment of the present disclosure may include the following steps 110-130:

At step 110, a feature map is normalized by respectively using different normalization factors, to obtain a candidate normalized feature map corresponding to each of the normalization factors. In some embodiments, K normalization factors are respectively used to normalize a feature map to obtain a candidate normalized feature map corresponding to each of the K normalization factors. Wherein K is an integer greater than 1.

In an embodiment of the present disclosure, feature maps corresponding to an image to be processed may be obtained first, wherein the image to be processed may be any of images to be normalized. By extracting image features of different dimensions from the image to be processed, the feature maps corresponding to the image to be processed may be obtained, wherein a number of feature maps may be N, and N is a positive integer.

Wherein the image features may include a color feature, a texture feature, a shape feature, etc. in the image. The color feature is a global feature, which describes a surface color attribute of an object corresponding to the image. The texture feature is also a global feature, which describes a surface texture attribute of the object corresponding to the image. The shape feature has two types of representations, one is a contour feature and the other is a region feature, the contour feature of the image mainly corresponds to the outer boundary of the object, and the region feature of the image is related to the shape of the image region.

In an embodiment of the present disclosure, the image features of the image to be processed may be extracted by a pre-trained neural network. The neural network may include, but be not limited to, VGG Net (Visual Geometry Group Network), GoogleNet (Google Network), etc. It is also possible to use other methods to extract the image features of the image to be processed, which is not specifically limited here.

In an embodiment of the present disclosure, different normalization factors refer to different normalization processing methods, including but not limited to a Batch Normalization (BN) method, a Layer Normalization (LN) method, an Instance Normalization (IN) method, and a Group Normalization (GN) method.

Before normalizing feature maps by respectively using different normalization factors, a statistic Ω corresponding to each of the normalization factors are determined first, wherein the statistic Ω may include a variance and/or a mean. Here statistics Ω and the normalization factors have a one-to-one correspondence, i.e., one normalization factor corresponds to one statistic or one set of statistics Ω.

Further, different statistics Ω are respectively used to normalize the feature map, to obtain a candidate normalized feature map corresponding to each of the normalization factors.

For example, if a number of feature maps is N, and a total number of normalization factors is K, N sets of candidate normalized feature maps may be obtained, and each set of candidate normalized feature maps includes K candidate normalized feature maps.

At step 120, for each of the normalization factors, a first weight value for the normalization factor is determined.

In an embodiment of the present disclosure, for each of the normalization factors corresponding to the feature map, the first weight value for the normalization factor may be determined adaptively based on the feature map.

The first weight value for the normalization factor is used to indicate a weight of the candidate normalized feature map obtained after normalizing the feature map by the normalization factor to the K candidate normalized feature maps. In an embodiment of the present disclosure, K first feature vectors corresponding to the feature map may be determined by the K normalization factors, and the first weight value for each of the normalization factors is obtained based on correlation between the K first feature vectors.

At step 130, a target normalized feature map corresponding to the feature map is determined based on the candidate normalized feature map corresponding to each of the normalization factors and the first weight value for each of the normalization factors.

In an embodiment of the present disclosure, for each of the candidate normalized feature maps, a first normalized feature map corresponding to the candidate normalized feature map is obtained by multiplying the candidate normalized feature map and the first weight value for the normalization factor corresponding to the candidate normalized feature map; the first normalized feature map is sized based on a second weight value for the normalization factor corresponding to the candidate normalized feature map, to obtain a second normalized feature map corresponding to the candidate normalized feature map; and the second normalized feature map is moved based on a target offset value for the normalization factor corresponding to the candidate normalized feature map, to obtain a third normalized feature map corresponding to the candidate normalized feature map. Finally, each of the third normalized feature maps is summed up to obtain the target normalized feature map corresponding to the feature map.

Wherein, the second weight value is used to adjust the size of the first normalized feature map by scaling down or scaling up the first normalized feature map, such that the scaled second normalized feature map matches the size requirement corresponding to the target normalized feature map. The second weight value may be determined during the training of the neural network, based on the size of the sample image, and the size of the normalized feature map that the neural network eventually needs to output, and once the training of the neural network is completed, the second weight value remains unchanged for the same normalization factor.

The target offset value is used to move the second normalized feature map, so that the positions of the moved third normalized feature maps overlap up and down, to facilitate the subsequent summation of the third normalized feature maps. The target offset value may also be determined during the training of the neural network, based on the size of the sample image, and the size of the normalized feature map that the neural network eventually needs to output, and once the training of the neural network is completed, the target offset value remains unchanged for the same normalization factor.

Furthermore, in an embodiment of the present disclosure, a number of target normalized feature maps is the same as the number of feature maps.

For example, the number of feature maps is N, and the number of target normalized feature maps finally obtained is also N.

In the above embodiment, different normalization factors may be used to normalize the feature map, respectively, to obtain the candidate normalized feature maps corresponding to each of the normalization factors. The target normalized feature map corresponding to the feature map are determined, based on the candidate normalized feature map corresponding to each of the normalization factors and the first weight value for each of the normalization factors. Therefore, the purpose of adaptively determining the first weight values of different normalization factors based on the feature map is realized, and the flexibility of the normalization algorithm is improved.

In some embodiments, the first weight value for each of the normalization factors is determined by using the following formula (1):

λₙ^{k}=F(Xₙ,Ω^{k};θ) (1)

Wherein Xₙ represents the n-th feature map, λₙ^{k} represents the first weight value of the k-th normalization factor corresponding to the n-th feature map, k represents any integer from 1 to K, K represents the total number of normalization factors, Ω^{k} represents a statistic, including a mean μ^{k} and/or a variance σ^{k}, calculated based on the k-th normalization factor, F (.) represents a function used to calculate the first weight value of the k-th normalization factor, and θ represents a learnable parameter.

In some embodiments, when the number of feature maps is multiple, the processing for each of the feature maps is in a consistent manner, and for convenience in description, n of the formula (1) may be ignored, and the feature maps may be represented by only one feature map X, i.e., in the following embodiments of the present disclosure, it is necessary to determine the first weight value for each of the normalization factors corresponding to the feature map X.

As shown in FIG. 2, step 120 may include steps 121 to 123.

At step 121, for each of the normalization factors, a first feature vector corresponding to the normalization factor is determined.

In an embodiment of the present disclosure, a second feature vector x corresponding to each of the normalization factors is obtained by subsampling the feature map. The statistic Ω corresponding to the normalization factor is determined by using the normalization factor, and the second feature vector x corresponding to the normalization factor is normalized based on the statistic Ω, to obtain a third feature vector \hat{x} corresponding to the normalization factor, wherein a number of the third feature vectors is K. The first feature vector z is obtained after performing dimensionality reduction on the third feature vector \hat{x}, wherein a number of the first feature vectors is also K.

At step 122, a correlation matrix is determined based on correlation between the first feature vectors corresponding to each of the normalization factors.

In an embodiment of the present disclosure, the correlation between a plurality of first feature vectors may be described, based on a product between each of the first feature vectors z and a transpose vector z^{T} corresponding to each of the first feature vectors z, so as to determine the correlation matrix ν.

At step 123, the first weight value for each of the normalization factors is determined based on the correlation matrix.

In an embodiment of the present disclosure, the correlation matrix ν may be converted into a candidate vector through a first fully connected network, tanh (hyperbolic tangent) transformation and a second fully connected network in turn, and then a target vector λ is obtained after normalizing the candidate vector. The first weight value for each of the normalization factors is obtained based on the target vector λ.

In the above embodiment, the first feature vector corresponding to each of the normalization factors may be determined based on each of the normalization factors first, and then the correlation between each of the first feature vectors is determined, and thereby the first weight value of each of the normalization factors is determined, therefore, simple implementation and high usability is achieved.

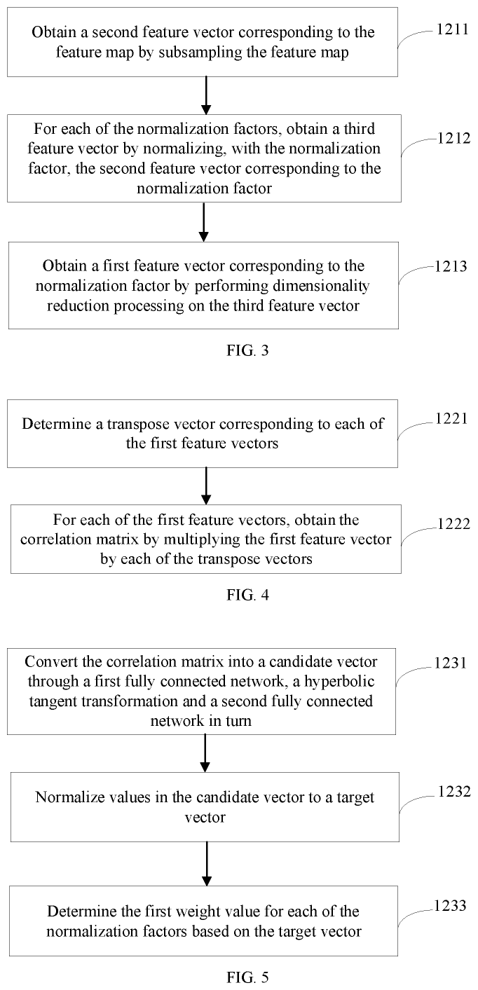

In some embodiments, as shown in FIG. 3, step 121 may include steps 1211 to 1213.

At step 1211, a second feature vector corresponding to the feature map is obtained by subsampling the feature map.

In an embodiment of the present disclosure, the feature map may be subsampled by averaging pooling or maximum pooling to obtain K second feature vectors corresponding to the feature map. In the present disclosure, the n-th feature map is represented by Xₙ, the processing for each of the feature maps is in a consistent manner, and for convenience in description, n is ignored, and the feature maps may be represented by X. After subsampling, K second feature vectors x corresponding to the feature map may be obtained. Wherein x has C dimensions, C is a number of channels of the feature map.

At step 1212, for each of the normalization factors, a third feature vector is obtained by normalizing, with the normalization factor, the second feature vector corresponding to the normalization factor.

In an embodiment of the present disclosure, the statistic Ω corresponding to the normalization factor may be calculated based on each of the normalization factors, wherein Ω includes a mean and/or a variance. In an embodiment of the present disclosure, Ω may include both variance and the mean.

According to the statistic Ω, K third feature vectors \hat{x} are obtained by normalizing the second feature vectors x respectively, wherein \hat{x} also has C dimensions.

At step 1213, a first feature vector corresponding to the normalization factor is obtained by performing dimensionality reduction processing on the third feature vector.

In an embodiment of the present disclosure, the dimensionality may be reduced by using a convolution, and in order to reduce the computational overhead of the dimensionality reduction processing, the convolution operation is performed in groups, and the quotient of the number C of channels corresponding to the feature map and a preset hyperparameter r is used as a number of said groups, for example, the number of channels corresponding to the feature map X is C, and the preset hyperparameter is r, then the number of said groups is C/r. It may be ensured that during the entire dimensionality reduction processing, an amount of parameters is constant as C, and K first feature vectors are obtained, and the first feature vector z has C/r dimensions.

In the above embodiment, K second feature vectors are obtained, after subsampling the feature map. K third feature vectors are obtained by normalizing the K second feature vectors respectively by using the K normalization factors, and then K first feature vectors are obtained by performing dimensionality reduction processing on the K third feature vectors. It is convenient to determine the first weight values for different normalization factors, and the usability is high.

In some embodiments, as shown in FIG. 4, step 122 may include steps 1221 to 1222.

At step 1221, a transpose vector corresponding to each of the first feature vectors is determined.

In an embodiment of the present disclosure, a corresponding transpose vector z^{T} may be determined for each of the first feature vectors z.

At step 1222, for each of the first feature vectors, the correlation matrix is obtained by multiplying the first feature vector by each of the transpose vectors.

In an embodiment of the present disclosure, any of the first feature vectors z is multiplied with any of the transpose vectors z^{T}, and finally the correlation matrix ν may be obtained. Wherein ν has K×K dimensions. In some embodiments, for example, with K=5 and C/r=3, a first transpose vector corresponding to the first feature vector 1 [a₁, a₂, a₃] is determined, a second transpose vector corresponding to the first feature vector 2 [b₁, b₂, b₃] is determined, a third transpose vector corresponding to the first feature vector 3 [c₁, c₂, c₃] is determined, a fourth transpose vector corresponding to the first feature vector 4 [d₁, d₂, d₃] is determined, and a fifth transpose vector corresponding to the first feature vector 5 [e₁, e₂, e₃] is determined; the first feature vector 1 is multiplied with the first transpose vector, the second transpose vector, the third transpose vector, the fourth transpose vector and the fifth transpose vector respectively, to obtain elements of a first row of the correlation matrix; the first feature vector 2 is multiplied with the first transpose vector, the second transpose vector, the third transpose vector, the fourth transpose vector and the fifth transpose vector respectively, to obtain elements of a second row of the correlation matrix; the first feature vector 3 is multiplied with the first transpose vector, the second transpose vector, the third transpose vector, the fourth transpose vector and the fifth transpose vector respectively, to obtain elements of a third row of the correlation matrix; the first feature vector 4 is multiplied with the first transpose vector, the second transpose vector, the third transpose vector, the fourth transpose vector and the fifth transpose vector respectively, to obtain elements of a fourth row of the correlation matrix; the first feature vector 5 is multiplied with the first transpose vector, the second transpose vector, the third transpose vector, the fourth transpose vector and the fifth transpose vector respectively, to obtain elements of a fifth row of the correlation matrix. In this way, the correlation matrix with K×K dimensions is obtained.

In the above embodiment, for each of the first feature vectors, the product of the first feature vector and each of the transpose vectors is used to describe the correlation between the plurality of first feature vectors, to obtain the correlation matrix, so as to subsequently determine the first weight values for different normalization factors, and the usability is high.

In some embodiments, as shown in FIG. 5, step 123 may include steps 1231 to 1233.

At step 1231, the correlation matrix is converted into a candidate vector through a first fully connected network, a hyperbolic tangent transformation and a second fully connected network in turn.

In an embodiment of the present disclosure, the dimensions of the correlation matrix ν are K×K, the correlation matrix ν is inputted into the first fully connected network first, wherein the fully connected network refers to a neural network composed of fully connected layers, each node of each layer of the neural network is connected to each node of the adjacent network layers. Then the dimensions of the correlation matrix ν are converted from K×K to πK , through the tanh (hyperbolic tangent) transformation, wherein π is a preset hyperparameter which may be a positive integer selected arbitrarily, e.g., 50.

Further, the dimensions may then be converted form πK to K, through the second fully connected network, to obtain the candidate vector with K dimensions.

At step 1232, values in the candidate vector is normalized to a target vector.

In an embodiment of the present disclosure, the values of the candidate vector with K dimensions may be normalized by a normalization function, such as a softmax function, to ensure Σₖλₖ=1,so as to obtain the target vector λ with K dimensions after normalization. In an embodiment of the present disclosure, when determining the target normalized feature map corresponding to one feature map, λₖ and λ^{k} may be used interchangeably.

At step 1233, the first weight value for each of the normalization factors is determined based on the target vector.

In an embodiment of the present disclosure, the target vector λ=[λ₁,λ₂, . . . ,λₖ]^{T} has K dimensions, and the value of the k-th dimension in the target vector may be used as the first weight value for the k-th normalization factor.

In the above embodiment, the dimensions of the correlation matrix may be converted into a candidate vector through the first fully connected network, the hyperbolic tangent transformation and the second fully connected network in turn, and then the values of the candidate vector are normalized to obtain the target vector normalized, so as to determine the first weight values for different normalization factors based on the target vector, and the usability is high.

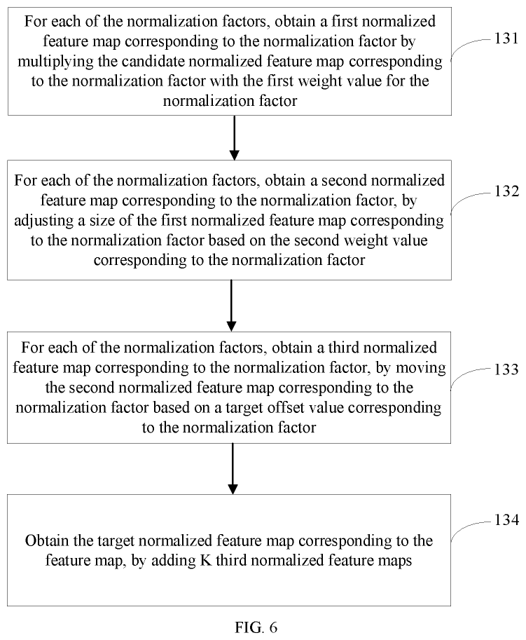

In some embodiments, as shown in FIG. 6, step 130 may include steps 131 to 134.

At step 131, for each of the normalization factors, a first normalized feature map corresponding to the normalization factor is obtained by multiplying the candidate normalized feature map corresponding to the normalization factor with the first weight value for the normalization factor.

In an embodiment of the present disclosure, for each of the normalization factors, the feature map is normalized by the normalization factor to obtain candidate normalized feature maps corresponding to the normalization factor, and the candidate normalized feature map is multiplied with the first weight value of the corresponding normalization factor to obtain the first normalized feature map.

At step 132, for each of the normalization factors, a second normalized feature map corresponding to the normalization factor is obtained, by adjusting a size of the first normalized feature map corresponding to the normalization factor based on the second weight value corresponding to the normalization factor.

In an embodiment of the present disclosure, the second weight value remains unchanged for the same normalization factor after the training of the neural network is completed. The size of the corresponding first normalized feature map is adjusted by multiplying the second weight value corresponding to the normalization factor with the corresponding first normalized feature map, to obtain the second normalized feature map. The size of the second normalized feature map is the same as a size needed for a final target normalized feature map.

At step 133, for each of the normalization factors, a third normalized feature map corresponding to the normalization factor is obtained, by moving the second normalized feature map corresponding to the normalization factor based on a target offset value corresponding to the normalization factor.

In an embodiment of the present disclosure, the target offset value remains unchanged for the same normalization factor after the training of the neural network is completed. The corresponding second normalized feature map is moved by adding the target offset value corresponding to the normalization factor to the corresponding second normalized feature map, to obtain the third normalized feature map. The positions of the third normalized feature maps corresponding to each of the normalization factors are overlapped up and down.

At step 134, the target normalized feature map corresponding to the feature map is obtained, by adding K third normalized feature maps.

In an embodiment of the present disclosure, the positions of each of the third normalized feature maps are overlapped up and down, and the pixel values at the same position of each of the third normalized feature maps are summed to finally obtain the target normalized feature map \hat{X} corresponding to the feature map X.

In an embodiment of the present disclosure, step 103 may be expressed by the following formula (2):

$$\hat{X} = {Σ}_{k} [ {γ}^{k} ( {λ}_{k} \frac{X - {μ}^{k}}{\sqrt{{( {σ}^{k} )}^{2} + ε}} ) + {β}^{k} ] . \qquad ( 2 )$$

Wherein \hat{X} represents the target normalized feature map corresponding to the feature map X. λₖ represents the first weight value for the k-th normalization factor. μ^{k} represents the mean of the statistic Ω^{k} corresponding to the k-th normalization factor. σ^{k} represents the variance of the statistic Ω^{k} corresponding to the k-th normalization factor. ϵ is a preset value to avoid that the denominator in the formula (2) is also zero when the variance is zero. γ^{k} represents the second weight value corresponding to the k-th normalization factor, which is equivalent to a scale parameter and is used to scale the first normalized feature map. β^{k} represents the target offset value corresponding to the k-th normalization factor, which is equivalent to an offset parameter and is used to move the second normalized feature map. The target normalized feature map \hat{X} that meets a final size requirement may be obtained with γ^{k} and β^{k}.

It can be seen from the formula (2) that the mean μ^{k} and variance σ^{k} use the same weight value. If the image to be processed is a sample image from the training process, the overfitting phenomenon caused by different weight values for the mean and variance may be avoided. In an embodiment of the present disclosure, each of the candidate normalized feature maps is linearly combined, by the weight values corresponding to different normalization factors instead of different normalization factors, so that the normalization algorithm is more flexible and more usable.

Furthermore, in an embodiment of the present disclosure, the second weight value and the target offset value are introduced for each of the normalization factors in order to obtain a more optimized target normalized feature map. Wherein the second weight value and the target offset value may be obtained during the training of a normalization layer of the neural network, and remain unchanged for the same normalization factor after the training is completed.

In the above embodiment, for each of the normalization factors, the candidate normalized feature map corresponding to the normalization factor is multiplied with the first weight value for the normalization factor, to obtain the first normalized feature map corresponding to the normalization factor; the first normalized feature map corresponding to the normalization factor is sized and moved by the second weight value and the target offset value corresponding to the normalization factor; the third normalized feature maps obtained by the size adjustment and movement are added to obtain the target normalized feature map corresponding to the feature map. Thus, the target normalized feature map corresponding to the feature map may be determined flexibly in accordance with different normalization factors, and any normalization layer in various neural networks may be replaced in practical applications, it is easy to implement and optimize.

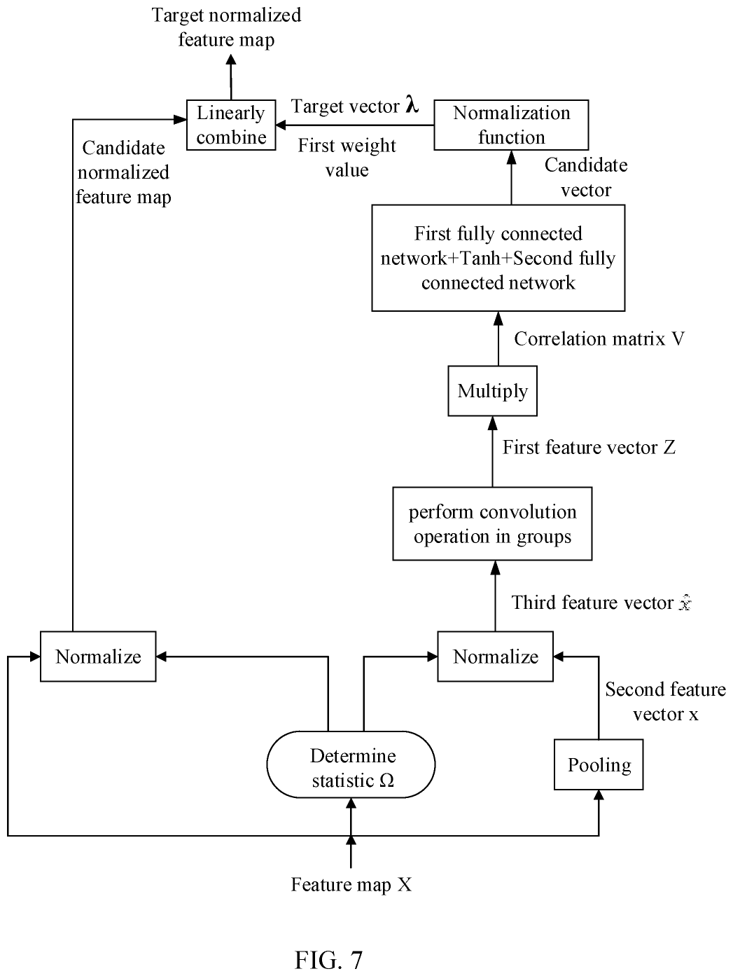

In some embodiments, as shown in FIG. 7, a schematic diagram of normalization process of image is provided.

For the feature map X, the normalization factor k may be used to calculate the statistic Ω^{k} corresponding to the normalization factor k, the statistic Ω^{k} includes the mean μ^{k} and variance σ^{k}, the feature map X is normalized based on the statistics Ω¹,Ω², . . . Ω^{k}, . . . Ω^{K}, respectively, and K candidate normalized feature maps may be obtained.

Furthermore, the feature map X may be subsampled by averaging pooling or maximum pooling to obtain K second feature vectors x corresponding to the feature map X. According to the statistics Ω¹,Ω², . . . Ω^{k}, . . . Ω^{K}, K third feature vectors \hat{x} are obtained by normalizing the second feature vectors x, respectively. K first feature vectors z corresponding to the feature map X are obtained, after dimensionality reduction of the K third feature vectors \hat{x} by convolution operation in groups.

The transpose vector z^{T} corresponding to each of the first feature vectors z may be determined. The correlation between multiple first feature vectors may be described by multiplying any of the first feature vectors z with any of the transpose vectors z^{T}, and finally the correlation matrix is obtained. Wherein ν has K×K dimensions.

The correlation matrix ν is inputted into the first fully connected network, and then the dimensions of the correlation matrix ν are converted from K×K to πK, through the tanh transformation, wherein π is a preset hyperparameter which may be a positive integer selected arbitrarily, e.g., 50. Further, the dimensions may then be converted form πK to K, through the second fully connected network, to obtain the candidate vector.

A normalization function, such as a softmax function, is used to normalize the candidate vector, and Σₖλₖ=1 obtain the normalized target vector λ=[λ₁, λ₂, . . . , λₖ]^{T}, and a value of each dimension of the target vector λ is used as the first weight value for the corresponding normalization factor. Therefore, the first weight values for different normalization factors are determined based on the feature map, and the flexibility of the normalization algorithm is improved.

K first normalized feature maps are obtained by multiplying each of the K candidate normalized feature maps with the first weight value λₖ for the corresponding normalization factor. K second normalized feature maps are obtained by multiplying each of the K first normalized feature maps with the second weight value γ^{k}. K third normalized feature maps are obtained by adding each of the K second normalized feature maps to the target offset value β^{k}. Finally, the target normalized feature map \hat{X} corresponding to the feature map X is obtained by adding the K third normalized feature maps together, wherein γ^{k} and β^{k} is not shown in FIG. 7.

In the above embodiment, the scope of image normalization processing methods for analysis is expanded by determining the first weight values of different normalization factors, and such that it is possible to analyze data content of different granularities within the same framework, and the frontier development of deep learning normalization technology is promoted. Furthermore, overfitting phenomenon of the entire network may be reduced while optimizing and stabilizing, by designing the above image normalization processing method. Said normalization layer may replace any normalization layer in the network structure. The method has the advantages of easy implementation and optimization, plug and play, etc., compared with other normalization processing methods.

In some embodiments, the image normalization processing method may be used to train the neural network when the image to be processed is a sample image, and the neural network obtained after training may be used as a sub-network to replace the normalization layer in the neural network used to perform various tasks. Wherein the various tasks include, but are not limited to, semantic understanding, speech recognition, computer vision tasks, etc.

During the training process, the above process may be used to adaptively determine first weight value corresponding to each of the normalization factors based on sample images for different tasks, so that the problem of inflexibility of the normalization algorithm is solved, which is caused by the inability to dynamically adjust weight values for the normalization factors in the case of different sets of samples.

In an embodiment of the present disclosure, if the training of the neural network is completed for a sample image of a certain task, a normalization layer in the neural network corresponding to the task may be directly replaced to achieve the purpose of plug-and-play. If there is a neural network corresponding to other tasks, said normalization layer may directly replace any normalization layer in a new neural network by fine tuning network parameters, such that the performance of other tasks is improved.

The present disclosure also provides an embodiment of an apparatus, corresponding to the above-mentioned embodiments of the method.

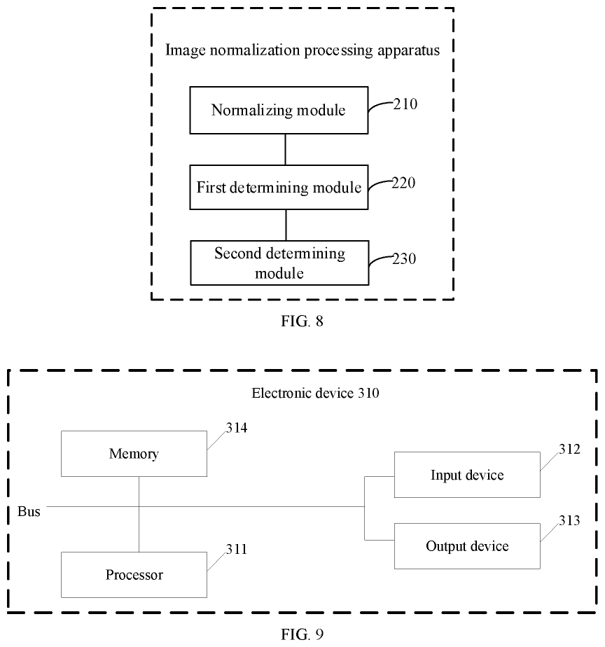

As shown in FIG. 8, FIG. 8 is a schematic structural diagram of an image normalization processing apparatus in accordance with an exemplary embodiment of the present disclosure, the apparatus includes: a normalizing module 210, configured to normalize a feature map by respectively using K normalization factors to obtain K candidate normalized feature maps, wherein the K candidate normalized feature maps and the K normalization factors have a one-to-one correspondence, and K is an integer greater than 1; a first determining module 220, configured to, for each of the K normalization factors, determine a first weight value for the normalization factor; and a second determining module 230, configured to determine a target normalized feature map corresponding to the feature map, based on the candidate normalized feature map corresponding to each of the K normalization factors and the first weight value for each of the K normalization factors.

In some embodiments, the first determining module includes: a first determining sub-module, configured to, for each of the normalization factors, determine a first feature vector corresponding to the normalization factor; a second determining sub-module, configured to determine a correlation matrix based on correlation between K first feature vectors; and a third determining sub-module, configured to determine the first weight value for each of the K normalization factors based on the correlation matrix.

In some embodiments, the first determining sub-module includes: a subsampling unit, configured to obtain K second feature vectors corresponding to the feature map by subsampling the feature map; a first normalizing unit, configured to obtain a third vector by normalizing, with the normalization factor, the second feature vector corresponding to the normalization factor in the K second feature vectors; and a dimensionality reduction processing unit, configured to obtain the first feature vector by performing dimensionality reduction processing on the third feature vector.

In some embodiments, the second determining sub-module includes: a first determining unit, configured to determine a transpose vector corresponding to each of the first feature vectors; and a second determining unit, configured to, for each of the first feature vectors, obtain the correlation matrix by multiplying the first feature vector by each of the transpose vectors.

In some embodiments, the third determining sub-module includes: a converting unit, configured to convert the correlation matrix into candidate vector through a first fully connected network, a hyperbolic tangent transformation and a second fully connected network in turn; a second normalizing unit configured to normalize values of the candidate vector to obtain a target vector; and a third determining unit, configured to determine the first weight value for each of the K normalization factors based on the target vector, wherein the target vector includes K elements.

In some embodiments, the third determining unit includes: using a k-th element in the target vector as the first weight value for the k-th normalization factor, wherein k is any integer from 1 to K.

In some embodiments, the second determining module includes: a fourth determining sub-module, configured to, for each of the normalization factors, obtain a first normalized feature map corresponding to the normalization factor by multiplying the candidate normalized feature map corresponding to the normalization factor with the first weight value for the normalization factor; a fifth determining sub-module, configured to, for each of the normalization factors, obtain a second normalized feature map corresponding to the normalization factor, by adjusting a size of the first normalized feature map corresponding to the normalization factor based on a second weight value corresponding to the normalization factor; a sixth determining sub-module, configured to, for each of the normalization factors, obtain a third normalized feature map corresponding to the normalization factor, by moving the second normalized feature map corresponding to the normalization factor based on a target offset value corresponding to the normalization factor; and a seventh determining sub-module, configured to the target normalized feature maps corresponding to the feature maps, by adding K third normalized feature maps.

Since embodiments of the device substantially correspond to embodiments of the method, relevant parts may be referred to the description of the embodiments of the method. The embodiments of the device described above are merely schematic, wherein the units described as separate components may or may not be physically separate, and the components displayed as units may or may not be physical units, i.e., the components displayed as units may be located in one place, or distributed to a plurality of network units. Some or all these modules may be selected according to actual needs to achieve the purpose of the solution of the present disclosure. It may be understood and implemented by those skilled in the art without inventive work.

An embodiment of the present disclosure provides a computer-readable storage medium storing a computer program. When being executed by a processor, the computer program causes the processor to implement the image normalization processing method according to any one of the above embodiments. The computer-readable storage medium includes a non-transitory computer-readable storage medium.

In some embodiments, the present disclosure provides a computer program product including computer-readable codes, when the computer-readable codes run on a device, a processor in the device is caused to execute instructions for implementing the image normalization processing method according to any one of the above embodiments.

In some embodiments, the present disclosure further provides another computer program product for storing computer-readable instructions. When being executed, the computer-readable instructions cause the computer to implement the image normalization processing method according to any one of the above embodiments.

The computer program product may be implemented by hardware, software or a combination thereof. In some embodiments, the computer program product may be embodied as a computer storage medium, in some embodiments, the computer program product may be embodied as a software product, such as a Software Development Kit (SDK) and so on.

An embodiment of the present disclosure further provides an electronic device, which includes: a processor; and a memory for storing instructions executable by the processor; wherein the processor is configured to execute the instructions stored in the memory to implement the image normalization processing method according to any one of the above embodiments.

FIG. 9 is a schematic structural diagram of a hardware structure of the electronic device in accordance with an embodiment of the present disclosure. The electronic device 310 includes a processor 311 and may further include an input device 312, an output device 313, and a memory 314. The input device 312, the output device 313, the memory 314 and the processor 311 are coupled with each other via a bus.

The memory 314 includes, but is not limited to, Random Access Memory (RAM), Read-Only Memory (ROM), Erasable Programmable Read Only Memory (EPROM), or Compact Disc Read-Only Memory (CD-ROM), or portable read-only memory (compact disc read-only memory, CD-ROM). The memory is configured to store associated instructions and data.

The input device 312 is configured to input data and/or signals, and the output device 313 is configured to output data and/or signals. The output device 313 and the input device 312 may be separate devices or an integral device.

The processor 311 may include is one or more processors, such as one or more central processing units (CPUs), and in the case where the processor 311 is a CPU, the CPU may be a single-core CPU or a multi-core CPU.

The memory 314 is configured to store program codes and data of a network device.

The processor 311 is configured to execute the program codes and data in the memory 314 to implement the steps in the above embodiments of the method. The details may be found in the description of embodiments of the method, and no more tautology here.

It will be understood that FIG. 9 illustrates only a simplified design of an image normalization processing apparatus. In practical applications, the image normalization processing apparatus may further include other necessary components, including but not limited to any number of input/output devices, processors, controllers, memories, etc., and all image normalization processing apparatus that may implement embodiments of the present disclosure are within the scope of the present disclosure.

Other implementations of the present disclosure will be apparent to those skilled in the art from consideration of the specification and practice of the present disclosure herein. The present disclosure is intended to cover any transformations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

The above are only some embodiments of the present disclosure and are not intended to limit the present disclosure, any modifications, equivalent substitutions, improvements, etc. made within the spirit and principle of the present disclosure shall be covered by the scope of the present disclosure.

1. An image normalization processing method, comprising:
normalizing a feature map by respectively using K normalization factors, to obtain K candidate normalized feature maps, wherein the K candidate normalized feature maps and the K normalization factors have a one-to-one correspondence, and K is an integer greater than 1;
for each of the K normalization factors, determining a first weight value for the normalization factor; and
determining a target normalized feature map corresponding to the feature map based on the candidate normalized feature map corresponding to each of the K normalization factors and the first weight value for each of the K normalization factors.

2. The image normalization processing method according to claim 1, wherein, for each of the K normalization factors, determining the first weight value for the normalization factor comprises:
for each of the K normalization factors, determining a first feature vector corresponding to the normalization factor;
determining a correlation matrix based on correlations between K first feature vectors corresponding to the K normalization factors; and
determining the first weight value for each of the K normalization factors based on the correlation matrix.

3. The image normalization processing method according to claim 2, wherein, for each of the K normalization factors, determining the first feature vector corresponding to the normalization factor comprises:
subsampling the feature map to obtain K second feature vectors corresponding to the feature map;
normalizing, with the normalization factor, a second feature vector corresponding to the normalization factor in the K second feature vectors to obtain a third feature vector; and
performing dimensionality reduction processing on the third feature vector to obtain the first feature vector.

4. The image normalization processing method according to claim 2, wherein determining the correlation matrix based on the correlations between the K first feature vectors comprises:
determining a respective transpose vector corresponding to each of the K first feature vectors; and
for each of the K first feature vectors, obtaining the correlation matrix by multiplying the first feature vector by each of the respective transpose vectors corresponding to the K first feature vectors.

5. The image normalization processing method according to claim 2, wherein determining the first weight value for each of the K normalization factors based on the correlation matrix comprises:
converting the correlation matrix into a candidate vector by sequentially using a first fully connected network, a hyperbolic tangent transformation, and a second fully connected network;
normalizing values in the candidate vector to obtain a target vector; and
determining the first weight value for each of the K normalization factors based on the target vector, wherein the target vector comprises K elements.

6. The image normalization processing method according to claim 5, wherein determining the first weight value for each of the K normalization factors based on the target vector comprises:
using a k-th element in the target vector as the first weight value for a k-th normalization factor, where k is an integer in a range from 1 to K.

7. The image normalization processing method according to claim 1, wherein determining the target normalized feature map corresponding to the feature map based on the candidate normalized feature map corresponding to each of the K normalization factors and the first weight value for each of the K normalization factors comprises:
for each of the K normalization factors,
obtaining a first normalized feature map corresponding to the normalization factor by multiplying the candidate normalized feature map corresponding to the normalization factor with the first weight value for the normalization factor;
obtaining a second normalized feature map corresponding to the normalization factor by adjusting a size of the first normalized feature map corresponding to the normalization factor based on a second weight value corresponding to the normalization factor;
obtaining a third normalized feature map corresponding to the normalization factor by moving the second normalized feature map corresponding to the normalization factor based on a target offset value corresponding to the normalization factor; and
obtaining the target normalized feature map corresponding to the feature map by adding K third normalized feature maps corresponding to the K normalization factors.

8. An electronic device, comprising:
at least one processor; and
at least one memory,
wherein the at least one memory stores machine-readable instructions executable by the at least one processor to perform operations comprising:
normalizing a feature map by respectively using K normalization factors, to obtain K candidate normalized feature maps, wherein the K candidate normalized feature maps and the K normalization factors have a one-to-one correspondence, and K is an integer greater than 1;
for each of the K normalization factors, determining a first weight value for the normalization factor; and
determining a target normalized feature map corresponding to the feature map based on the candidate normalized feature map corresponding to each of the K normalization factors and the first weight value for each of the K normalization factors.

9. The electronic device according to claim 8, wherein, for each of the K normalization factors, determining the first weight value for the normalization factor comprises:
for each of the K normalization factors, determining a first feature vector corresponding to the normalization factor;
determining a correlation matrix based on correlations between K first feature vectors corresponding to the K normalization factors; and
determining the first weight value for each of the K normalization factors based on the correlation matrix.

10. The electronic device according to claim 9, wherein, for each of the K normalization factors, determining the first feature vector corresponding to the normalization factor comprises:
subsampling the feature map to obtain K second feature vectors corresponding to the feature map;
normalizing, with the normalization factor, a second feature vector corresponding to the normalization factor in the K second feature vectors to obtain a third feature vector; and
performing dimensionality reduction processing on the third feature vector to obtain the first feature vector.

11. The electronic device according to claim 9, wherein determining the correlation matrix based on the correlations between the K first feature vectors comprises:
determining a respective transpose vector corresponding to each of the K first feature vectors; and
for each of the K first feature vectors, obtaining the correlation matrix by multiplying the first feature vector by each of the respective transpose vectors corresponding to the K first feature vectors.

12. The electronic device according to claim 9, wherein determining the first weight value for each of the K normalization factors based on the correlation matrix comprises:
converting the correlation matrix into a candidate vector by sequentially using a first fully connected network, a hyperbolic tangent transformation, and a second fully connected network;
normalizing values in the candidate vector to obtain a target vector; and
determining the first weight value for each of the K normalization factors based on the target vector, wherein the target vector comprises K elements.

13. The electronic device according to claim 12, wherein determining the first weight value for each of the K normalization factors based on the target vector comprises:
using a k-th element in the target vector as the first weight value for a k-th normalization factor, where k is an integer in a range from 1 to K.

14. The electronic device according to claim 8, wherein determining the target normalized feature map corresponding to the feature map based on the candidate normalized feature map corresponding to each of the K normalization factors and the first weight value for each of the K normalization factors comprises:
for each of the K normalization factors,
obtaining a first normalized feature map corresponding to the normalization factor by multiplying the candidate normalized feature map corresponding to the normalization factor with the first weight value for the normalization factor;
obtaining a second normalized feature map corresponding to the normalization factor by adjusting a size of the first normalized feature map corresponding to the normalization factor based on a second weight value corresponding to the normalization factor;
obtaining a third normalized feature map corresponding to the normalization factor by moving the second normalized feature map corresponding to the normalization factor based on a target offset value corresponding to the normalization factor; and
obtaining the target normalized feature map corresponding to the feature map by adding K third normalized feature maps corresponding to the K normalization factors.

15. A non-transitory computer-readable storage medium storing one or more computer programs executable by at least one processor to perform operations comprising:
normalizing a feature map by respectively using K normalization factors, to obtain K candidate normalized feature maps, wherein the K candidate normalized feature maps and the K normalization factors have a one-to-one correspondence, and K is an integer greater than 1;
for each of the K normalization factors, determining a first weight value for the normalization factor; and
determining a target normalized feature map corresponding to the feature map based on the candidate normalized feature map corresponding to each of the K normalization factors and the first weight value for each of the K normalization factors.

16. The non-transitory computer-readable storage medium according to claim 15, wherein, for each of the K normalization factors, determining the first weight value for the normalization factor comprises:
for each of the K normalization factors, determining a first feature vector corresponding to the normalization factor;
determining a correlation matrix based on correlations between K first feature vectors corresponding to the K normalization factors; and
determining the first weight value for each of the K normalization factors based on the correlation matrix.

17. The non-transitory computer-readable storage medium according to claim 16, wherein, for each of the K normalization factors, determining the first feature vector corresponding to the normalization factor comprises:
subsampling the feature map to obtain K second feature vectors corresponding to the feature map;
normalizing, with the normalization factor, a second feature vector corresponding to the normalization factor in the K second feature vectors to obtain a third feature vector; and
performing dimensionality reduction processing on the third feature vector to obtain the first feature vector.

18. The non-transitory computer-readable storage medium according to claim 16, wherein determining the correlation matrix based on the correlations between the K first feature vectors comprises:
determining a respective transpose vector corresponding to each of the K first feature vectors; and
for each of the K first feature vectors, obtaining the correlation matrix by multiplying the first feature vector by each of the respective transpose vectors corresponding to the K first feature vectors.

19. The non-transitory computer-readable storage medium according to claim 16, wherein determining the first weight value for each of the K normalization factors based on the correlation matrix comprises:
converting the correlation matrix into a candidate vector by sequentially using a first fully connected network, a hyperbolic tangent transformation, and a second fully connected network;
normalizing values in the candidate vector to obtain a target vector, wherein the target vector comprises K elements; and
determining the first weight value for each of the K normalization factors based on the target vector by using a k-th element in the target vector as the first weight value for a k-th normalization factor, where k is an integer in a range from 1 to K.

20. The non-transitory computer-readable storage medium according to claim 15, wherein determining the target normalized feature map corresponding to the feature map based on the candidate normalized feature map corresponding to each of the K normalization factors and the first weight value for each of the K normalization factors comprises:
for each of the K normalization factors,
obtaining a first normalized feature map corresponding to the normalization factor by multiplying the candidate normalized feature map corresponding to the normalization factor with the first weight value for the normalization factor;
obtaining a second normalized feature map corresponding to the normalization factor by adjusting a size of the first normalized feature map corresponding to the normalization factor based on a second weight value corresponding to the normalization factor;
obtaining a third normalized feature map corresponding to the normalization factor by moving the second normalized feature map corresponding to the normalization factor based on a target offset value corresponding to the normalization factor; and
obtaining the target normalized feature map corresponding to the feature map by adding K third normalized feature maps corresponding to the K normalization factors.
